(19) United States
(12) Patent Application Publication
(10) Pub. No.: US 2010/0229513 A1
(43) Pub. Date: Sep. 16, 2010

(54) Air Filter for Internal Combustion Engines in Motor Vehicles and Method for Producing the Filter

(75) Inventors: Jobst Eisengraeber-Pabst, Benningen a.N. (DE); Matthaeus Huber, Reisbach (DE); Nikolaus Moser, Ditzingen (DE); Josef Rohrmeier, Iaberweinting (DE); Stefan Walz, Ludwigsburg (DE)

Correspondence Address: Mann+Hummel GMBH;Department VR-P, Hindenburgstr. 45, Ludwigsburg, 71638, DE

(73) Assignee: MANN+HUMMEL GMBH, Ludwidsburg (DE)

(21) Appl. No.: 12/694,722

(22) Filed: Jan. 27, 2010

Related U.S. Application Data
(63) Continuation of application No. PCT/EP2007/057746, filed on Jul. 27, 2007.

(51) Int. Cl. B01D 46/52; B01D 50/00; B32B 37/24; B32B 38/00; B32B 38/04

(52) U.S. Cl. 55/385.3; 156/227

(57) ABSTRACT

An air filter for internal combustion engines and interiors of motor vehicles has a filter insert in the form of a bellows of filter material folded in a zigzag shape by a first folding, wherein the bellows has a plurality of neighboring pockets extending in a longitudinal direction of the bellows, wherein between the pockets first folds are formed at ridges between the pockets. A seal is connected to the bellows. The folded filter material has a second folding in a direction transverse to the longitudinal direction and second folds are formed by the second folding that extend substantially transversely to the longitudinal direction. End faces extending transversely to the longitudinal direction are formed by cutting the bellows to a desired length. The seal extends across the end faces and longitudinal sides of the bellows.

### CROSS REFERENCE TO RELATED APPLICATIONS

This application is US continuation of international patent application PCT/EP2007/057746, filed Jul. 27, 2007 designating the United States of America, and published in German on Feb. 5, 2009 as WO 2009/015684 A1, the entire disclosure of which is incorporated herein by reference.

### TECHNICAL FIELD

The invention relates to an air filter, especially for internal combustion engines in motor vehicles and the interior of motor vehicles.

### BACKGROUND OF THE INVENTION

An air filter usually processes the intake air of the internal combustion engine before the air enters the engine. In the air filter the dirt particles are separated from the airflow, the airflow typically obtained from the surroundings of the motor vehicle. DE 102 00 673 A1 discloses an air filter in which a filter mat separates a filtered (clean) air section from an unfiltered (raw) air section in the air filter housing.

DE 102 31 696 A1 discloses a filter insert for arrangement in a filter housing. The filter insert is comprised of a bellows having filter material such as paper or nonwoven filter material folded in a zigzag shape so that a plurality of neighboring pockets are formed. The filter insert has thus a structure that is folded like an accordion in which the ridges of the pockets and the opposed end faces of the bellows are positioned in parallel planes. The bellows has substantially the shape of a flat parallelepiped wherein the folds on one side of the bellows define a main filter surface for the unfiltered air side of the air filter and the folds of the opposite pocket ridges positioned in a parallel plane delimit the filter surface for the clean air side. The known filter insert is provided in the area of the terminal edges of the bellows, i.e., at the ends of the bellows material, with a terminal cap of plastic material glued or welded to the ends so as to cover the entire surface area. The terminal cap is provided to reinforce the bellows and to secure it in the defined parallelepipedal shape in order to secure the filter insert in a seal-tight and stable way in the mounted position in the air filter housing.

In modern combustion engines used in motor vehicles, there is however only limited space available in the intake area for arranging the air filter between the adjoining engine devices. Therefore, the known filter insert having parallelepipedal shape and a corresponding size cannot be easily mounted in the space available at the internal combustion engine, in particular in case of irregular configurations of the available space.

Often, shaping of the filter housing is desirable that takes into consideration the available space and the engine geometry. DE 198 16 431 A1 discloses an embodiment of a filter insert in which the filter insert has a contour that matches that of the available mounting space. The contour is generated by different heights of the pockets in accordance with the mounting situation; the continuous zigzag fold arrangement is maintained. With the known filter element it is possible to provide an at least partially adapted shape of the filter insert but the manufacture of such a filter insert with entirely different pocket heights is complex and expensive.

### SUMMARY OF THE INVENTION

It is an object of the present invention to provide an air filter of the aforementioned kind with which, with simple constructive means, any adaptation of the shape of the filter insert in the mounted position to the available mounting space is possible.

Moreover, it is an object of the present invention to provide a method for producing an air filter of the aforementioned kind with which any shape of the filter insert can be produced in a simple way.

In accordance with the present invention, this is achieved in connection with the air filter in that the folded filter material has an additional folding in a second folding direction that extends transversely to a longitudinal direction of the bellows or the pockets so that second folds are generated that extend transversely to the longitudinal direction, wherein a front end face and a rear end face of the bellows that extend transverse to the longitudinal direction of the pockets are formed by a cut performed for cutting the bellows to length.

Also in accordance with the present invention, a method is disclosed in which a filter material such as paper, nonwoven or the like is folded in a zigzag shape in a first folding direction in such a way that a bellows with a plurality of neighboring pockets results wherein between the pockets first folds are formed and, subsequently, an additional folding in a second folding direction transverse to a longitudinal direction of the pockets is realized so that second folds are produced that extend substantially transversely to the longitudinal direction; the bellows formed in this way is then cut to a predetermined length and provided with a seal.

The invention includes a bellows with a first folding and first folds produced by the first folding and a second folding in a direction extending transversely to the longitudinal direction of the first folds and second folds produced thereby, wherein the folded filter material (i.e. the bellows) is cut to a desired length and then brought into a configuration that corresponds to the desired shape of the air filter. By means of the seal applied to the bellows, this configuration is maintained. The variety of possible bellows configurations provides a particular advantage in comparison to known filter inserts because with the invention any bellows configuration can be realized with seals in two planes (2D elements) or in three planes (3D elements).

By taking into consideration the mounting conditions, respectively, and the design of the bellows, it can be expedient to make the seal at the end faces and the seal at the longitudinal sides of the bellows from different material. The sealing action of the terminal edges that are produced by cutting to length can be realized, for example, by a framed bead of hot melt adhesive, spray-on adhesive, PUR foam application or an adhesive lateral strip. Particularly expedient is however that the seal is comprised of the same material on all sides of the bellows. In this way, the manufacture is simplified. As a sealing material, a sealing strip can be provided. It is however advantageously to provide a seal comprised of silicone or a PUR foam.

The seal can be positioned along the end faces or longitudinal sides at any height; this contributes to universal adaptation of the air filter to a particular housing configuration. In the case of seals whose material is applied by injection, casting or foaming, it is expedient to provide an additional positive-locking connection that in particular secured positioning of the seal at the desired level. For this purpose, outer folds located at the longitudinal sides have at the level of the seal outwardly projecting sections that project into the sealing material of the seal.

According to an advantageous embodiment of the invention, the seal is comprised of thixotropic PUR foam. This sealing material provides several advantages, in particular a simplified manufacture of the seal in case of three-dimensional configurations. For this purpose, an open manufacturing mold into which the bellows is inserted and the PUR foam is applied can be used. Also, broad sealing strips can be realized in a simple way. Also, it is possible to utilize different Shore hardness, wherein in two process steps a hard and a soft PUR components are applied. The hard component serves for reinforcing the element while the soft component provides the sealing action. It is particularly expedient to configure the seal as a sealing frame with circumferentially extending sealing surfaces. For forming a sealing frame, preferably a sealing material in liquid or paste-like state is applied at the level of the desired sealing position and subsequently cured or hardened.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a section of a bellows in a plan view;

FIG. 2 is a section along the line II-II of FIG. 1;

FIG. 3 is a plan view onto a bellows produced by first and second foldings;

FIG. 4 is a section view along the line IV-IV in FIG. 3;

FIG. 5 is a schematic illustration of a bellows with circumferentially extending seal;

FIG. 6 is a detail illustration of the detail VI of FIG. 5;

FIG. 7 is a perspective illustration of a filter insert that is of a three-dimensional configuration;

FIGS. 8a to 8i shows different geometric configurations that can be realized by a bellows according to FIG. 3;

FIGS. 9a to 9f illustrate different embodiments of seals made from PUR foam;

FIG. 10 is a schematic illustration of a filter insert having an irregular configuration;

FIG. 11 is a first view of a filter insert with a sealing profile extending in three planes;

FIG. 12 shows a second view of the filter insert of FIG. 11;

FIGS. 13a to 13c show different perspective illustrations of a mold for producing seals from thixotropic PUR foam;

FIG. 14 illustrates the manufacture of a seal made from a thixotropic PUR foam; and

FIG. 15 shows a finished filter insert in the mold according to FIGS. 13a to 13c.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components methods of manufacture related to an air filter apparatus. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

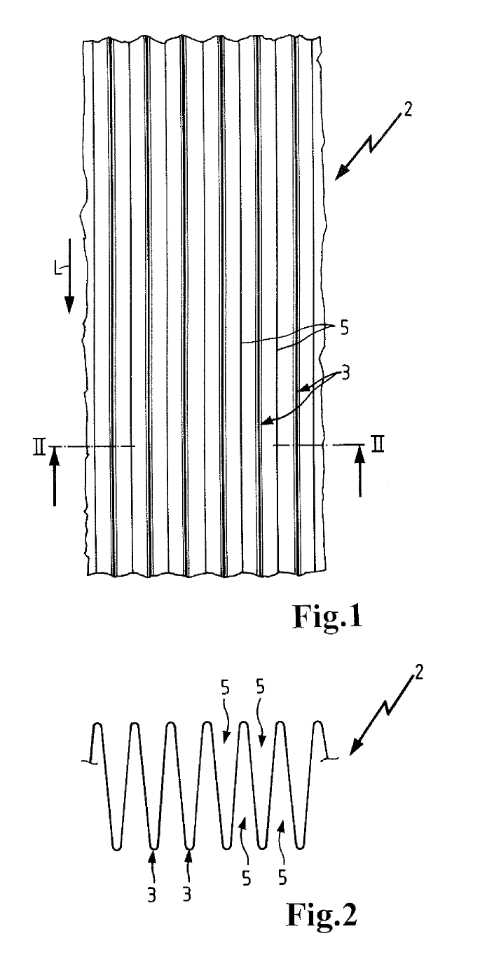

FIG. 1 illustrates a section of the bellows 2 in plan view. This bellows 2 is manufactured as endless material or in great lengths and then at a later time cut to the desired size by cuts transverse to the longitudinal direction L. In this state of manufacture the filter material, for example, paper or nonwoven, has been folded in a zigzag shape so that in the longitudinal direction L first folds 3 are formed. Between the folds 3 there are pockets 5 that also extend in the longitudinal direction L.

FIG. 2 shows a section along the line II-II in FIG. 1. This FIG. 2 shows that the filter material is folded in zigzag shape and in this way forms the bellows 2 wherein the bellows 2 forms a plurality of neighboring pockets 5 and at the ridges of the pockets 5 the first folds 3 are located, respectively. As already disclosed in connection with FIG. 1, the first folds 3 and the pockets 5 extend in the longitudinal direction L of the bellows 2.

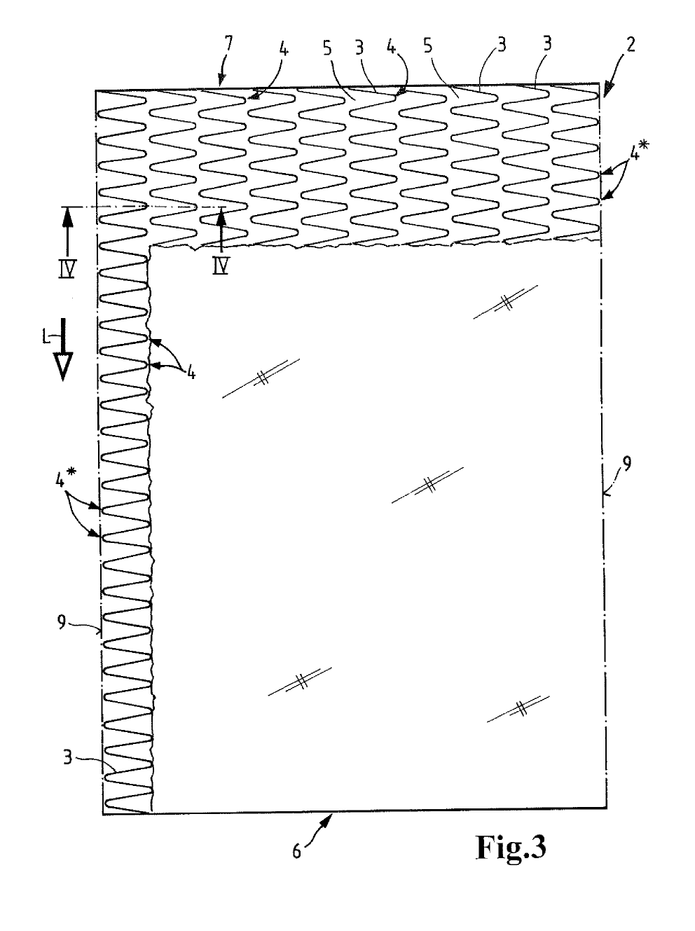

FIG. 3 shows a plan view onto a bellows 2 in a further state of manufacture wherein the filter material has an additional folding that is provided in a second folding direction transverse to the longitudinal direction L. In this way, a zigzag-shaped course of the first folds 3 is produced so that second folds 4 are formed that extends substantially orthogonally to the first folds 3. The pockets 5 are positioned between the first folds 3 that now extend in a zigzag shape. The bellows 2 illustrated in FIG. 3 is cut to the desired length in a direction transverse to the longitudinal direction L by appropriate cuts so that a front end face 6 and rear end face 7 are produced. The longitudinal sides 9 extend between the two end faces 6 and 7 in the longitudinal direction of the bellows 2. The longitudinal sides 9 are substantially defined by the second folds 4* positioned at the outer sides.

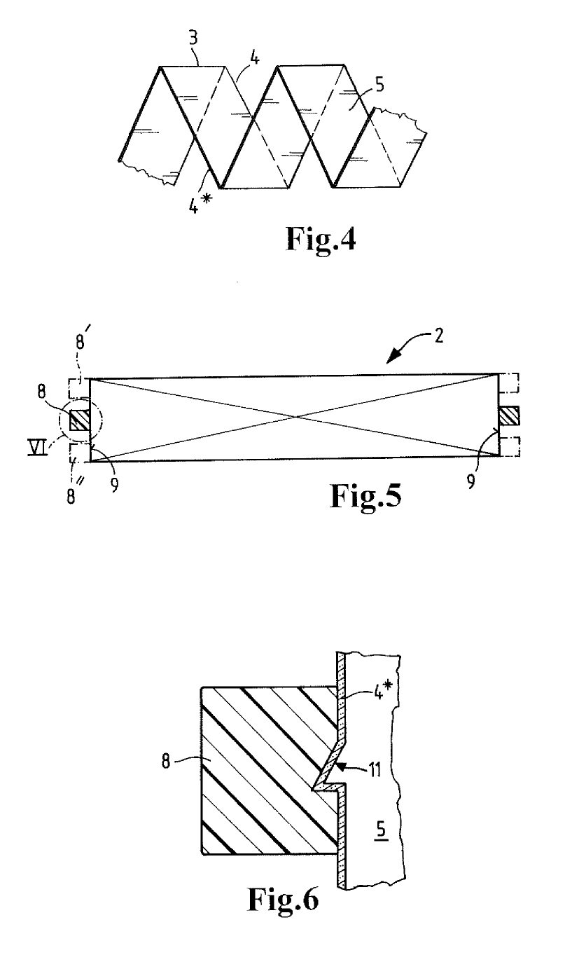

FIG. 4 shows a section along the line IV-IV in FIG. 3. This Figure illustrates that at the topside and the bottom side of the bellows 2, the first folds 3 are located that extends, as shown in FIG. 3, in a zigzag shape. This course results because of the additional folding transverse to the first folding which second folding produces the second folds 4, 4* that extend substantially orthogonally to the first folds 3. Accordingly, the pockets 5 are delimited by a first fold 3 and two second folds 4 extending substantially orthogonally to the first fold 3.

In FIG. 5 a schematic illustration of a bellows 2 with a circumferential seal 8 is shown. The seal 8 is comprised of silicone or PUR foam, for example. Since the longitudinal sides 9 of the bellows 2 are formed without a step, the seal 8 can be applied at any level on the longitudinal sides 9 as is illustrated, for example, by the dashed illustration of seals 8′ and 8″.

FIG. 6 shows a detail view of detail VI of FIG. 5. The illustrated embodiment shows seal 8 comprised of curable plastic material wherein for securing the position of the seal 8 relative to the height of the bellows 2 at the outer folds 4* a projecting section 11 is provided by means of which a positive-locking engagement between the filter material and the seal 8 relative to the height of the bellows results.

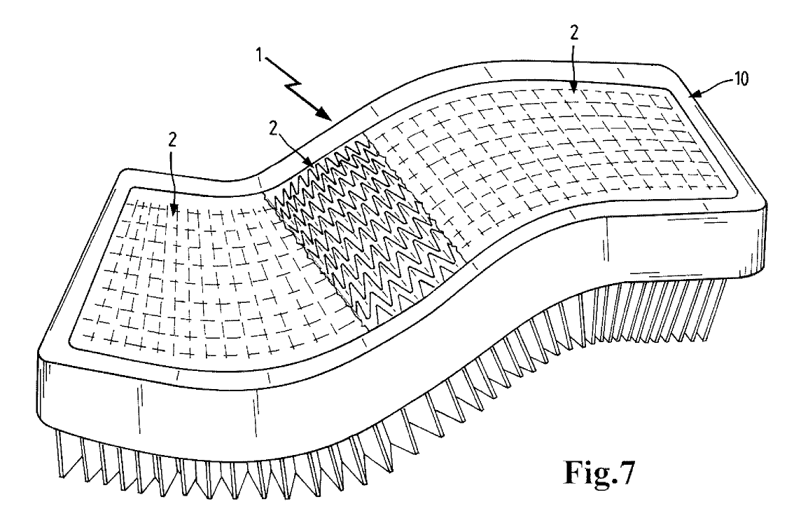

FIG. 7 shows a perspective illustration of a filter insert 1 configured in a three-dimensional embodiment. This filter insert 1 is comprised of bellows 2 and a sealing frame 10 surrounding the entire circumference. The sealing frame 10 is comprised, in this case advantageously, of a thixotropic PUR foam. However, any other suitable material can be employed. As shown in FIG. 7, the double folding of the filter material provides the possibility to configure the bellows 2 in any configuration in three planes wherein subsequently this configuration is secured by means of application of the sealing frame 10.

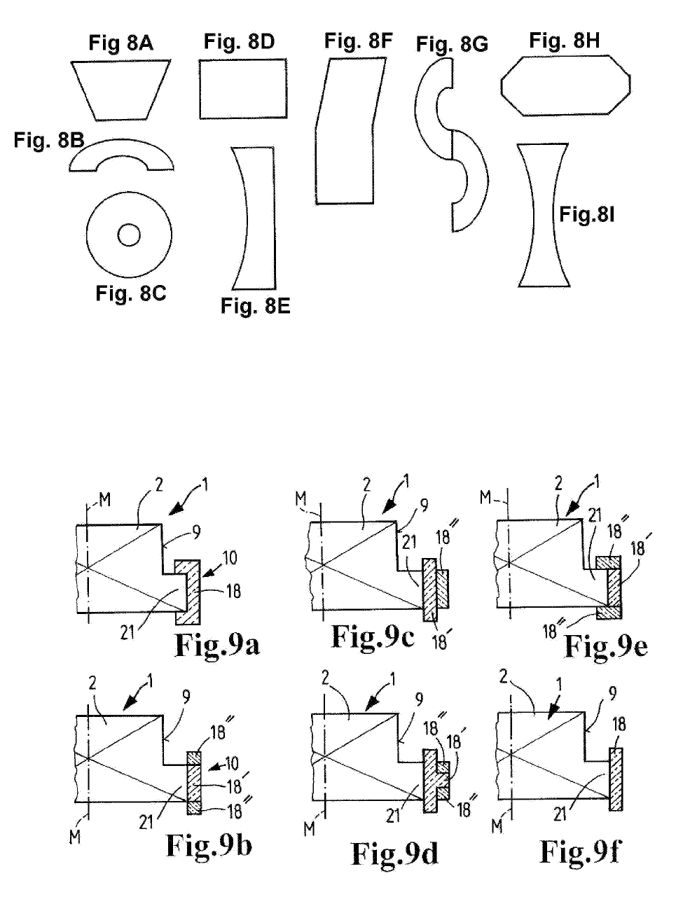

As a result of the double folding, wherein the second folding is realized substantially transversely to the first folding, there is the possibility of configuring the bellows in different shapes. For a configuration in two planes, i.e., length and width of the bellows, the shapes as illustrated in FIGS. 8a to 8 are possible, for example. This includes a trapezoid (FIG. 8a), a rectangle (FIG. 8d), an angled rectangle (FIG. 8f), an S shape (FIG. 8g), an essentially oval shape (FIG. 8h), an arc (FIG. 8b), a circular ring shape (FIG. 8c), a shape that is concave at one side (FIG. 8e), and a double-concave shape (FIG. 8i).

FIGS. 9a to 9f show different embodiments of seals 18 that are comprised, for example, of PUR foam and that surround as a sealing frame 10 the entire bellows. The schematic illustration of the embodiments is simplified so that the section view shows only one side of a filter insert 1 that is symmetric to the center axis M. In this connection, FIG. 9a shows a filter insert 1 in which the bellows 2 has at its longitudinal side 9 a lateral rim 21 of reduced fold height. At this lateral rim 21 the seal 18 is provided that is substantially of a U-shaped cross-section and therefore encloses the lateral rim 21 on three sides. FIG. 9b shows a filter insert 1 in which the bellows 2 has the same shape as in FIG. 9a. However, the seal comprises a sealing section 18′ of a hard PUR foam wherein sealing sections 18″ made from a softer PUR foam adjoin the sealing section 18′ at the top and the bottom. These materials of different hardness have the advantage that by means of the section 18′ the shape stability is provided while the sections 18″ provide excellent sealing action.

Modifications of a seal of two components of PUR foam are illustrated in FIGS. 9c, 9d, and 9e. FIG. 9f shows a variant of FIG. 9a and thus a seal 18 that is comprised exclusively of relatively harder PUR foam.

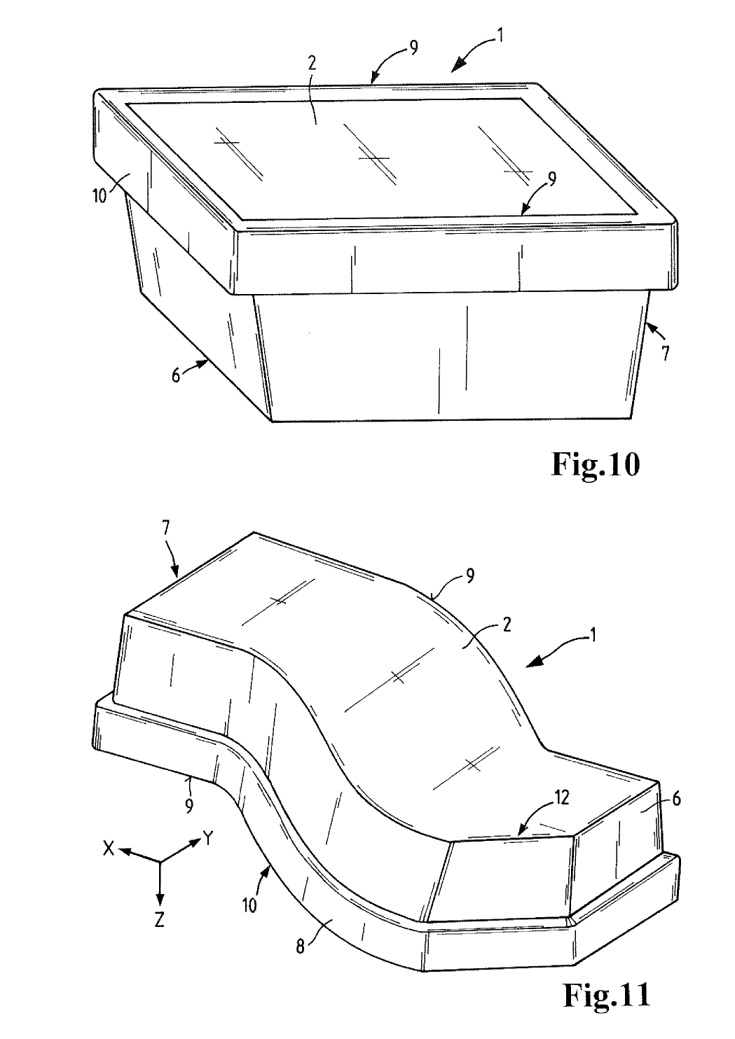

In FIG. 10 a schematic illustration of a filter insert of an irregular configuration is illustrated. The filter insert is comprised of a bellows 2 and a sealing frame 10 that surrounds the bellows 2 completely. FIG. 10 also shows that one of the longitudinal sides 9 is significantly shorter than the other longitudinal side 9 and that the front end face 6 is slanted relative to the rear end face 7. These different dimensions in different planes are possible as a result of the structure of the bellows 2 shown in FIGS. 3 and 4.

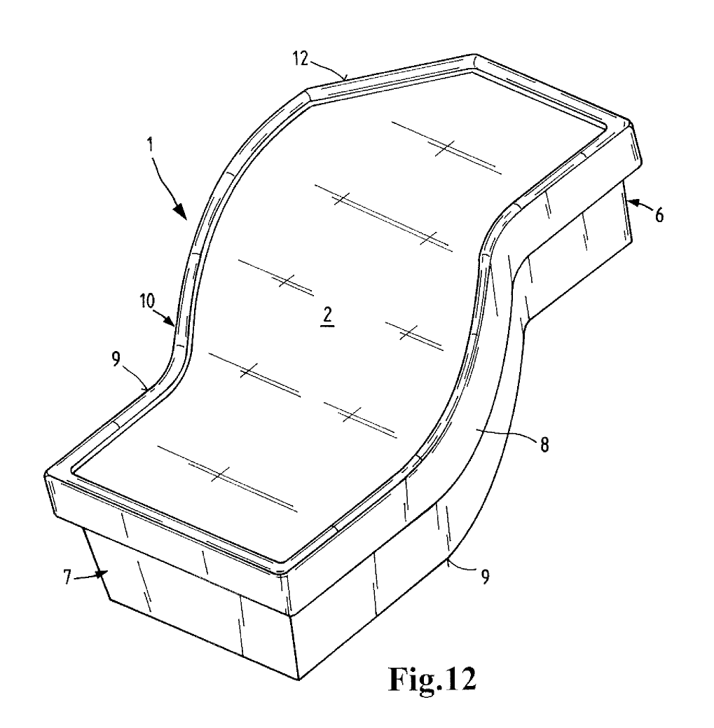

In FIG. 11 and FIG. 12 two different views of a filter insert 1 with a sealing profile 10 extending the three planes is illustrated. The longitudinal side 9 of the filter insert 1 extends in the plane X while the front end face 6 is substantially positioned in the plane Y. In the vertical direction, the bellows 2 extends in the direction Z. It is apparent that the area of the filter insert 1 neighboring the rear end face 7 is positioned in a plane that is higher than the area of the filter insert 1 that is adjacent to the front end face 6. Moreover, it is apparent that between the front end face 6 and the longitudinal side 9 facing forwardly in FIG. 11 there is an edge 12 so that at this location there is already a further irregularity in the shape of the filter insert 1. By means of such an edge 12 it is possible, for example, to take into account the space that is available for the filter insert 1. While FIG. 11 shows the filter insert 1 in a position in which the sealing frame 10 is arranged at the lower edge of the vertical height of the bellows 2, FIG. 12 shows this filter insert 1 in a view from the other side. In other respects, same reference numerals are used for same parts in FIGS. 11 and 12.

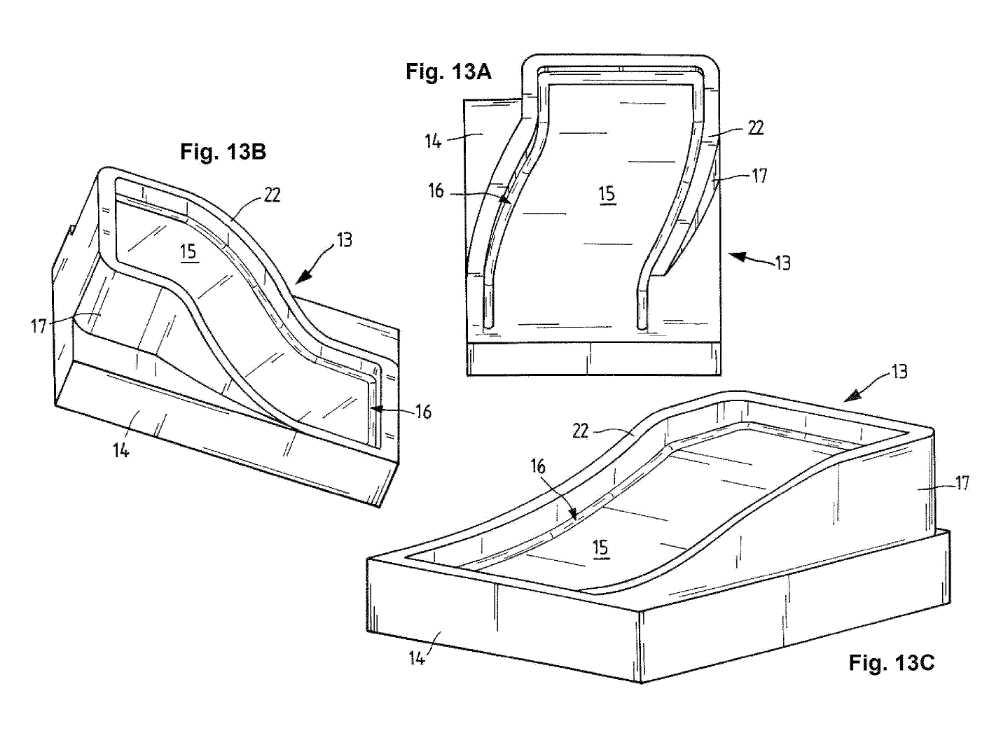

FIGS. 13a to 13c show different views of perspective illustrations of a mold for seals made from a thixotropic PUR foam. This mold 13 comprises a base 14 and a raised portion 17 wherein a rim 22 surrounds a receptacle 15 for the bellows. One area of the receptacle 15 is provided at a lower level and thus within the base 14 while another area of the receptacle 15 is positioned in the raised portion 17. The rim 22 surrounds the portion of the receptacle 15 that projects from the base 14. Along the rim 22 and also within the base 14, a groove 16 is provided that extends around the receptacle 15 for the bellows; the groove 16 serves for receiving a sealing materials so that the bellows can be provided with a seal or a sealing frame in order to produce a filter insert.

A mold as illustrated in FIGS. 13a to 13c is suitable in cases where the sealing material is flowable only to a limited extent or solidifies extremely fast after application. For such a manufacturing process, in particular a thixotropic PUR foam is suitable. In this way, it is avoided that the sealing material will flow into an area at the lower plane; instead, a sealing frame is produced that, at least approximately, corresponds to the course of the configuration of the bellows.

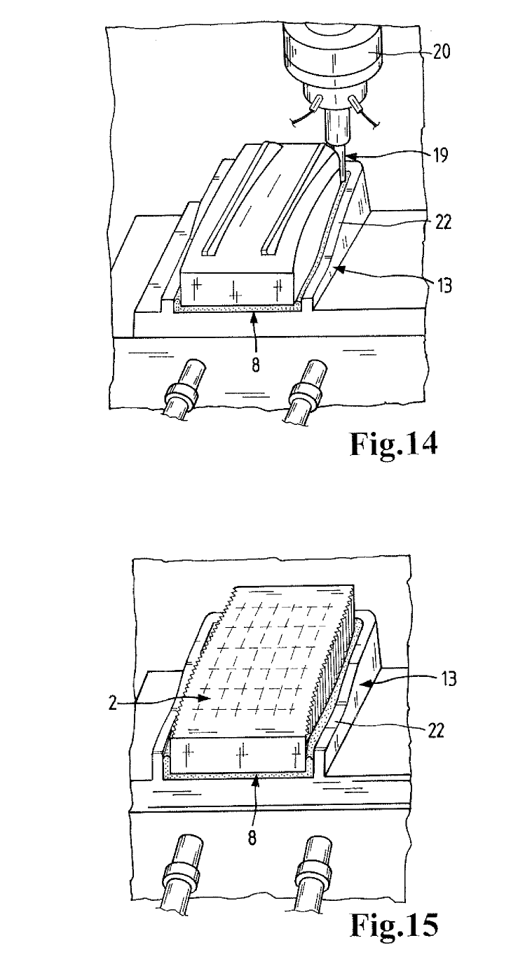

FIG. 14 shows bellows 2 that has been received in the described mold 13 of FIGS. 13a to 13c. Between the edge of the bellows 2 and the mold 13 or its rim 22 there is a spacing or gap into which, by means of an applicator 20 and a nozzle 19 arranged at its front end, the appropriate sealing material is applied. In this connection, the applicator 20 moves across the longitudinal sides and the end faces of the bellows and fills in this way the groove 16 shown in FIGS. 13a to 13c and extending along the edges of the bellows 2. The cast or injected or foamed material bonds to the filter material of the bellows 2 as has been disclosed in connection with FIG. 6. FIG. 15 shows the finished filter insert in the mold according to FIGS. 13a to 13c. Same reference numerals identify the same parts as in FIGS. 13 to 13c and 14.

In order to apply the seal, the bellows can be inserted into an injection mold and a stable sealing frame can be generated by injection molding. Alternatively, the bellows can be glued into an appropriately shaped receptacle or can be clipped into an appropriately shaped receptacle.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. An air filter for internal combustion engines and interiors of motor vehicles, said air filter comprising:
a filter insert comprising a bellows of filter material folded in a zigzag shape by a first folding,
wherein said bellows includes a plurality of neighboring pockets extending in a longitudinal direction of said bellows, wherein between said pockets first folds are formed at ridges between said pockets; and
at least one seal connected to said bellows;
wherein said folded filter material has a second folding in a direction transverse to said longitudinal direction so that second folds are formed that extend substantially transversely to said longitudinal direction; and
wherein end faces extending transversely to said longitudinal direction are formed by cutting said bellows to a desired length.

2. The air filter according to claim 1, wherein said at least one seal includes at least one seal extending across said end faces and at least one seal on longitudinal sides of said bellows, wherein said end face and longitudinal seals are comprised of different materials.

3. The air filter according to claim 1, wherein said at least one seal includes at least one seal extending across said end faces and at least one seal on longitudinal sides of said bellows, wherein said end face and longitudinal seals are comprised of the same material.

4. The air filter according to claim 1, wherein at least one of said seals is comprised of silicone or comprised of PUR foam.

5. The air filter according to claim 1, wherein at least one of said seals is comprised of a thixotropic PUR foam or comprised of a thermoplastic elastomer (TPE).

6. The air filter according to claim 1, wherein at least one of said seals has sections made of foams of different Shore hardness.

7. The air filter according to claim 6, wherein at least one of said seals is comprised of a two-component PUR foam.

8. The air filter according to claim 1, wherein longitudinal sides of said bellows extending between said end faces include outwardly projecting sections that project into a sealing material of at least one of said seals.

9. The air filter according to claim 1, wherein said filter material is a paper or a nonwoven material.

10. A method for producing an air filter, said method comprising:
folding in a first folding direction a filter material in a zigzag shape so that a bellows is produced having a plurality of neighboring pockets extending in a longitudinal direction of said bellows, wherein between said pockets first folds are formed at ridges between said pockets;
subsequently folding said filter material in a second folding direction transversely to said longitudinal direction of said pockets so that substantially transverse to said longitudinal direction second folds are produced in said bellows;
subsequently cutting said bellows to a desired length; and
applying a seal to said bellows.

11. The method according to claim 10, further comprising:
shaping said bellows in two or three dimensions into a desired configuration after said step of folding in said second folding direction and before said step of applying said seal,
wherein, in said step of applying a seal, a sealing material is applied across longitudinal sides and end faces of said bellows and said seal secures and fixes said desired configuration.

12. The method according to claim 10, wherein,
in said step of applying a seal, a sealing material in a liquid state or a pasty state is applied at a level of a desired sealing position and is then cured so that said seal is formed as a sealing frame.

13. The method according to claim 10, wherein,
in said step of applying a seal, said bellows is inserted into a closable mold and subsequently a sealing material is injected and then cured.

14. The method according to claim 10, wherein,
in said step of applying a seal, said bellows is inserted into an open mold and subsequently a thixotropic PUR foam is applied into a gap between said bellows and said open mold, in which gap said PUR foam solidifies.
